(19) United States
(12) Patent Application Publication
(10) Pub. No.: US 2024/0186631 A1
(43) Pub. Date: Jun. 6, 2024

(54) BATTERY PACK

(71) Applicant: MILWAUKEE ELECTRIC TOOL CORPORATION, Brookfield, WI (US)

(72) Inventors: Eli M. Zidel, Milwaukee, WI (US); Zachery Meyer, Hartland, WI (US); Wyatt R. Silha, Milwaukee, WI (US); Thomas A. Schmeling, Wauwatosa, WI (US); John G. Marx, Hartford, WI (US); Carmen J. Castaños, Milwaukee, WI (US); John L. Whealon, West Bend, WI (US)

(21) Appl. No.: 18/521,086

(22) Filed: Nov. 28, 2023

Related U.S. Application Data
(60) Provisional application No. 63/430,569, filed on Dec. 6, 2022.

(51) Int. Cl. H01M 50/211; H01M 50/262; H01M 50/284

(52) U.S. Cl. CPC H01M 50/211; H01M 50/262; H01M 50/284; H01M 2220/30

(57) ABSTRACT

A battery pack is disclosed and includes a battery housing, a core housing disposed within the battery housing, and at least one pouch cell disposed within the core housing, the pouch cells including at least one corner, wherein the core housing includes a baseplate, at least one sidewall extending from the baseplate, and a rear wall extending from the baseplate to the sidewall, wherein the rear wall meets the sidewall at a partial-cylindrical corner and wherein the partial-cylindrical corner provides clearance for the corner of the pouch cell.

### CROSS-REFERENCE TO RELATED APPLICATIONS

The present application claims priority to U.S. provisional application No. 63/430,569, filed Dec. 6, 2022, the entire contents of which are incorporated by reference herein.

### FIELD OF THE DISCLOSURE

The present disclosure relates to cordless power tools, and more particularly to batteries for cordless power tools.

### BACKGROUND OF THE DISCLOSURE

From do-it-yourself projects at home to large scale commercial construction projects, cordless power tools are ubiquitous. These tools have increased productivity and efficiency. These tools require battery packs that are constantly improving.

### SUMMARY OF THE DISCLOSURE

The present disclosure provides, in one aspect, a battery pack that includes a battery housing, a core housing disposed within the battery housing, and at least one pouch cell disposed within the core housing, the pouch cells including at least one corner, wherein the core housing includes a baseplate, at least one sidewall extending from the baseplate, and a rear wall extending from the baseplate to the sidewall, wherein the rear wall meets the sidewall at a partial-cylindrical corner and wherein the partial-cylindrical corner provides clearance for the corner of the pouch cell.

The present disclosure provides, in another aspect, a battery pack that includes a battery housing having an upper battery housing portion and a lower battery housing portion, a core housing disposed within the battery housing, at least one pouch cell disposed within the core housing, and at least one tongue-and-groove assembly that includes a tongue extending from an inner surface of the lower battery housing portion and a groove extending into an outer surface of the core housing, wherein the tongue of the lower battery housing portion fits into the groove on the core housing.

The present disclosure provides, in another aspect, a battery pack that includes a battery housing having an upper battery housing portion and a lower battery housing portion, a core housing disposed within the battery housing, the core housing include at least one printed circuit board assembly (PCBA) alignment tab extending therefrom, at least one pouch cell disposed within the core housing, and at least one PCBA disposed on the core housing, wherein the PCBA includes at least one alignment slot that fits around the PCBA alignment tab on the core housing.

Other features and aspects of the disclosure will become apparent by consideration of the following detailed description and accompanying drawings.

### BRIEF DESCRIPTION OF THE DRAWINGS

FIG. 1 is a perspective view of a battery pack.

FIG. 2 is a top plan view of the battery pack of FIG. 1.

FIG. 3 is a bottom plan view of the battery pack of FIG. 1.

FIG. 4 is a side plan view of the battery pack of FIG. 1.

FIG. 5 is a rear plan view of the battery pack of FIG. 1.

FIG. 6 is a front plan view of the battery pack of FIG. 1.

FIG. 7 is a side plan view of the battery pack of FIG. 1 with a lower battery housing portion removed.

FIG. 8 is a side plan view of the battery pack of FIG. 1 with a lower battery housing portion and a core housing removed.

FIG. 9 is a front perspective view of a core housing of the battery pack of FIG. 1.

FIG. 10 is a cross section view of the battery pack of FIG. 1 taken along line 10-10 in FIG. 4.

FIG. 11 is a detailed view of the battery pack of FIG. 1 taken at box 11 in FIG. 10.

FIG. 12 is a top plan view of the battery pack of FIG. 1 with an upper battery housing portion removed.

FIG. 13 is a front perspective view of the battery pack of FIG. 1 with a battery housing removed.

FIG. 14 is a rear perspective view of the battery pack of FIG. 1 with a battery housing removed.

FIG. 15 is a top plan view of a printed circuit board assembly (PCBA) for the battery pack of FIG. 1.

FIG. 16 is a front plan view of a front endplate for the battery pack of FIG. 1.

FIG. 17 is a bottom plan view of the front endplate of FIG. 16.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

Features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

### DETAILED DESCRIPTION

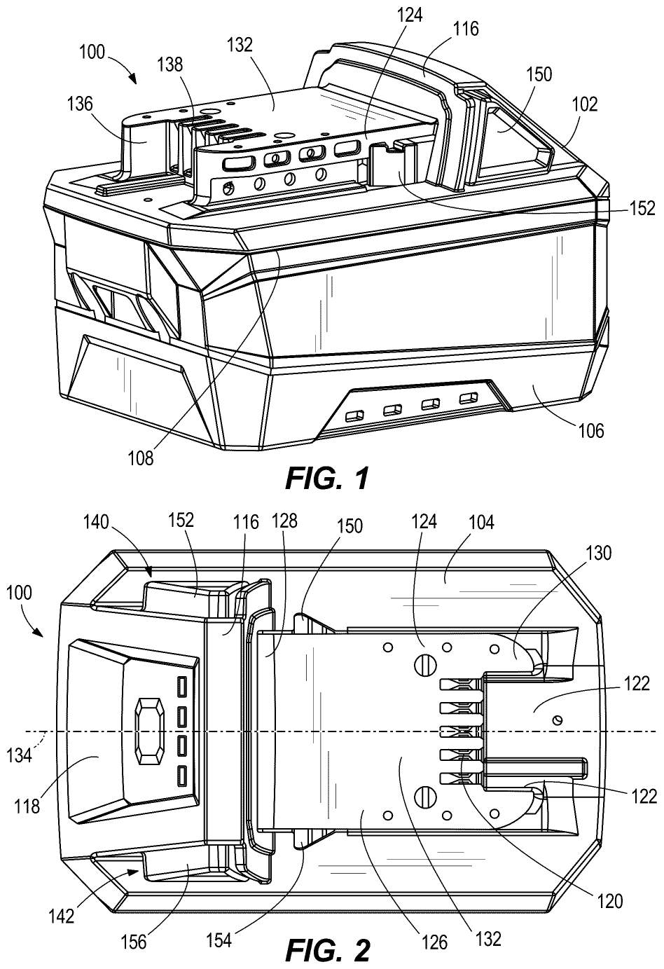

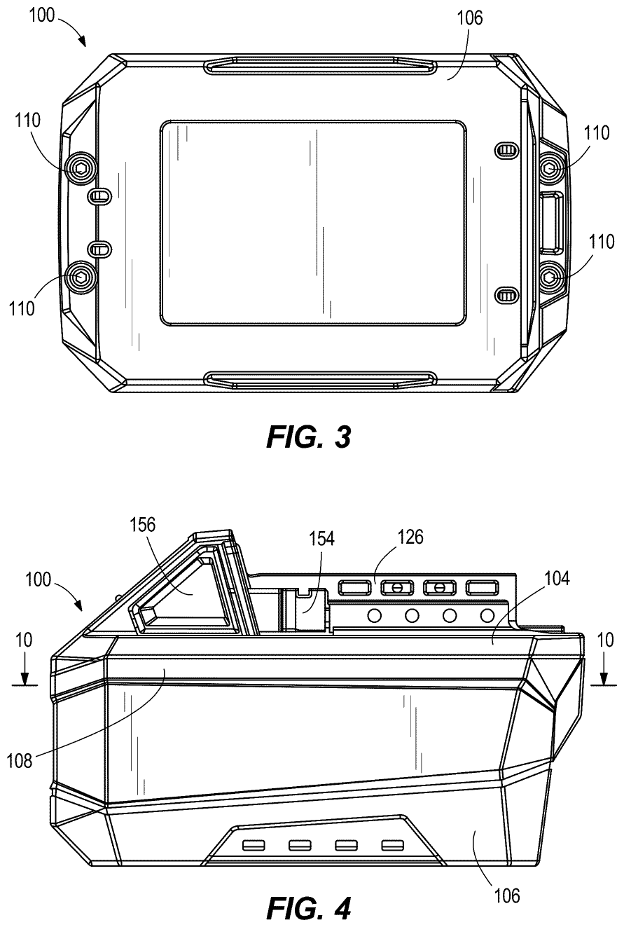

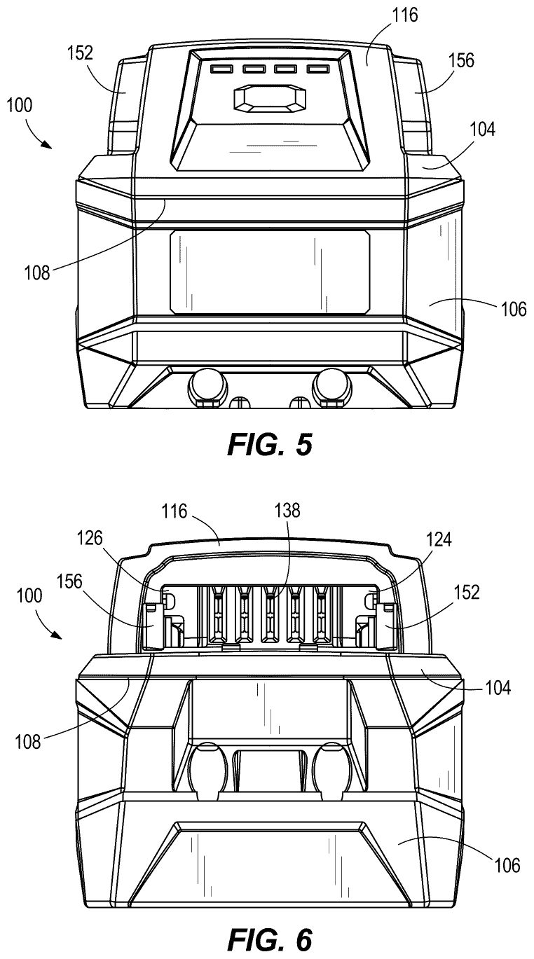

Referring to FIGS. 1-6, a battery pack 100 is illustrated. As shown, the battery pack 100 includes a battery housing 102 having an upper battery housing portion 104 coupled to a lower battery housing portion 106 along a seam 108, or interface, via a plurality of threaded fasteners 110 (e.g., screws). The upper battery housing portion 104 includes an upper surface 112 and a tool body engagement assembly 114 that extends therefrom. The tool body engagement assembly 114 includes a latch assembly housing 116 disposed on the upper battery housing portion 104 adjacent a first end 118 of the upper battery housing portion 104. A rail assembly 120 extends along the upper surface 112 of the upper battery housing portion 104 from the latch assembly housing 116 adjacent a second end 122 of the upper battery housing portion 104. The rail assembly 120 includes a first rail 124 and a second rail 126 that extend along the length of the rail assembly 120 from a first end 128 of the rail assembly 120 to a second end 130 of the rail assembly 120.

As shown, the rails 124, 126 extend outward from a central portion 132 of the rail assembly 120 away from a central axis 134 of the battery pack 100 such that the rails 124, 126 are parallel to the central axis 134. Each rail 124, 126 is generally shaped like an inverted “L” and is sized and shaped to fit into a complementary shaped feature on a battery receptacle of a cordless power tool. The tool body engagement assembly 114 further includes a recess 136 that extends into the second end 130 of the rail assembly 120 and terminates at a plurality of terminal openings 138. When the battery pack 100 is engaged with a battery receptacle on a cordless power tool, the terminal openings 138 will fit around one or more terminals within the cordless power tool and battery terminals within the terminal openings 138 will be operably coupled to each other to transmit direct current (DC) power from the battery pack 100 to the cordless power tool to provide DC power to a motor and other electrical components within the cordless power tool.

The tool body engagement assembly 114 also includes a first latch 140 and a second latch 142 disposed in the latch assembly housing 116 and partially extending into the first end 128 of the rail assembly 120. The first latch 140 includes a hook 150 and a release button 152. The second latch 142 also includes a hook 154 and a release button 156. The first latch 140 and the second latch 142 are biased outward relative to the central axis 134 via one or more springs. During use, when the battery pack 100 is engaged with a battery receptacle of a cordless power tool, the hooks 150, 154 engage complementary features of the battery receptable to retain the battery pack 100 in engagement with the cordless tool. When the release buttons 152, 156 are pressed by a user, the hooks 150, 154 are retracted and the battery pack 100 may be removed from the cordless power tool by sliding the battery pack 100 from the battery receptacle.

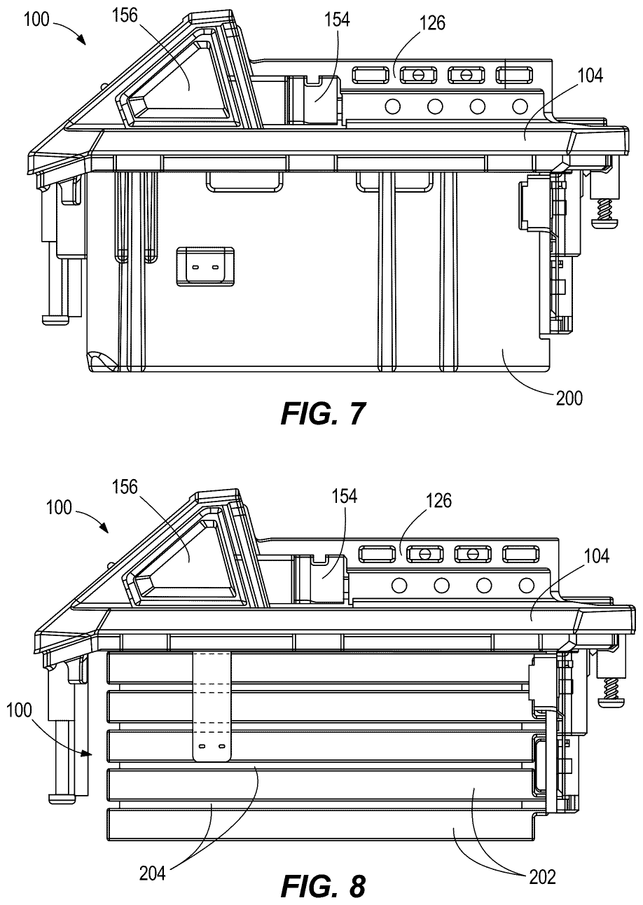

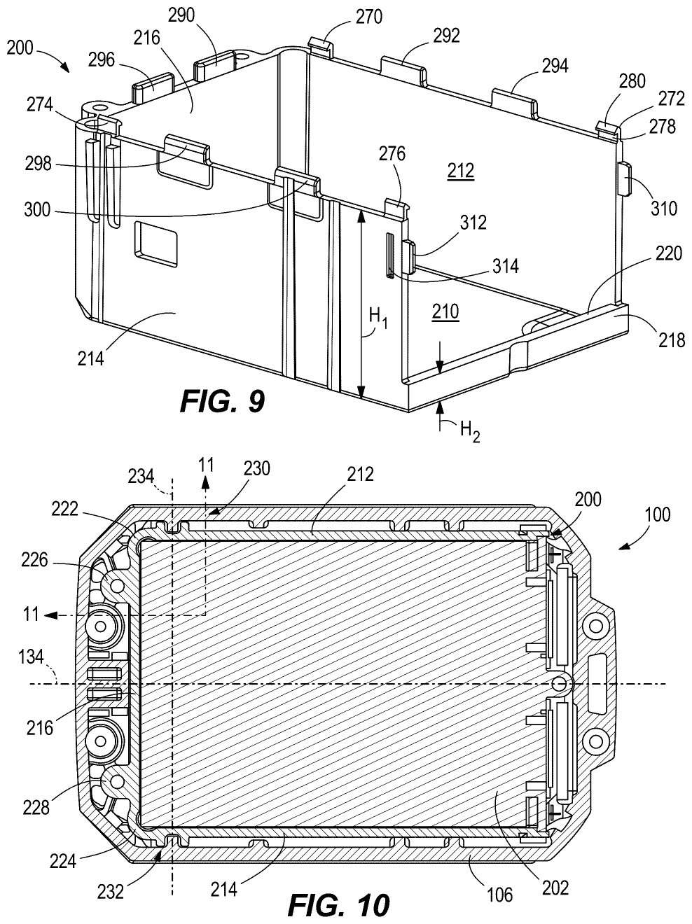

Referring to FIG. 7, the battery pack 100 includes a core housing 200 disposed within the battery housing 102. Further, as FIG. 8 shows, a plurality of pouch cells 202 are disposed within the core housing 200. The pouch cells 202 are electrically coupled to each other. Adjacent pouch cells 202 are separated by a plate 204, or spacer. FIG. 9 shows that the core housing 200 includes a base plate 210. A first sidewall 212 and a second side wall 214 extend perpendicularly from the base plate 210. The sidewalls 212, 214 are parallel to each other. A rear wall 216 extends perpendicularly from the base plate 210 between the sidewalls 212, 214. The rear wall 216 extends along the entire height of the sidewalls 212, 214 and is perpendicular to the sidewalls 212, 214. A front wall 218 also extends perpendicularly from the base plate 210 opposite the rear wall 218. The front wall 218 is parallel to the rear wall 216. Moreover, the front wall 218 only extends along a portion of the height of the sidewalls 212, 214 such that an opening 220 is formed in the front wall 218 between the sidewalls 212, 214.

As shown, each sidewall 212, 214 and the rear wall 216 have a height H₁ and the front wall has a height H₂. Further, the height H₂ is less than the height H₁. In particular, H₂ is less than or equal to 0.20 H₁, such as less than or equal to 0.19 H₁, less than or equal to 0.18 H₁, less than or equal to 0.17 H₁, less than or equal to 0.16 H₁, less than or equal to 0.15 H₁, or less than or equal to 0.14 H₁. Moreover, H₂ is greater than or equal to 0.07 H₁, such as greater than or equal to 0.08 H₁, greater than or equal to 0.09 H₁, greater than or equal to 0.10 H₁, greater than or equal to 0.11 H₁, greater than or equal to 0.12 H₁, or greater than or equal to 0.13 H₁. It is to be understood that H₂ can be within a range between, and including, any of the maximum and minimum values of H₂ disclosed herein.

FIG. 10 shows that the first side wall 212 meets the rear wall 216 at a first partial-cylindrical corner 222. Moreover, the second side wall 214 also meets the rear wall 216 at a second partial-cylindrical corner 224 opposite the first partial-cylindrical corner 222. While not shown, it is to be understood that the front wall 218 may also meet the sidewalls 212, 214 at partial-cylindrical corners. The partial-cylindrical corners 222, 224 are identical mirror images of each other.

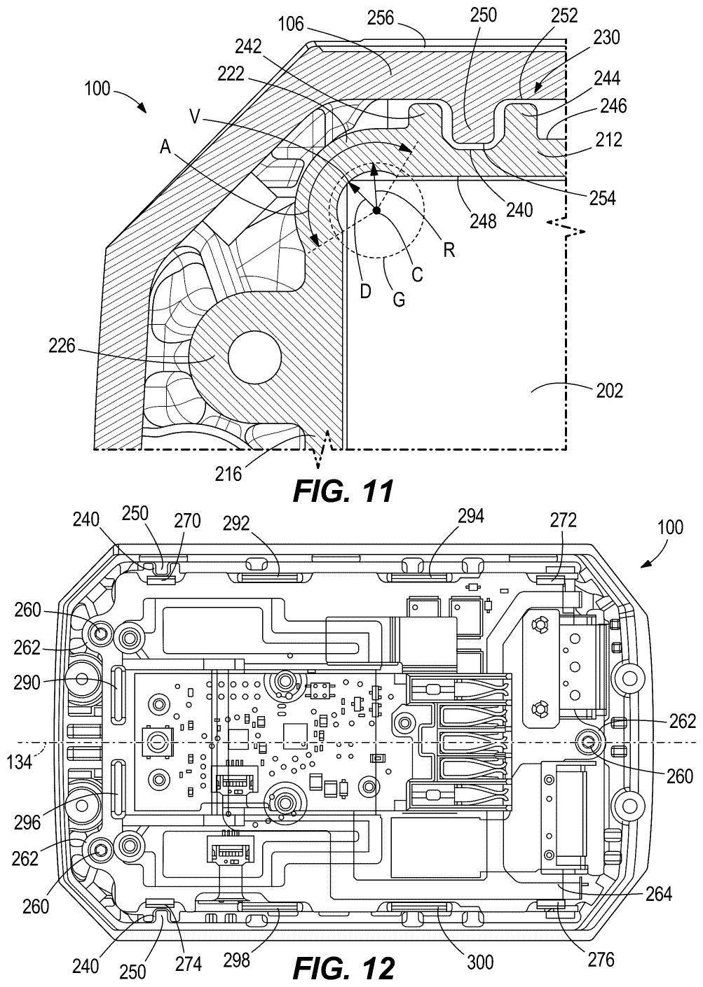

As illustrated in the detail view of FIG. 11, the first partial-cylindrical corner 222 extends over an arc A. In a particular aspect, the arc A is greater than or equal to one-hundred twenty degrees (120°), such as greater than or equal to one-hundred twenty-five degrees (125°), greater than or equal to one-hundred thirty degrees (130°), greater than or equal to one-hundred thirty-five degrees (135°), greater than or equal to one-hundred forty degrees (140°), greater than or equal to one-hundred forty-five degrees (145°), greater than or equal to one-hundred fifty degrees (150°), and greater than or equal to one-hundred fifty-five degrees (155°). In another aspect, the arc A is less than or equal to two-hundred degrees (200°), such as less than or equal to one-hundred ninety-five degrees (195°), less than or equal to one-hundred ninety degrees (190°), less than or equal to one-hundred eighty-five degrees (185°), less than or equal to one-hundred eighty degrees (180°), less than or equal to one-hundred seventy-five degrees (175°), less than or equal to one-hundred seventy degrees (170°), less than or equal to one-hundred sixty-five degrees (165°), or less than or equal to one-hundred sixty degrees (160°). It is to be understood that the arc A can be within a range between, and including, any of the values of A disclosed herein. Further, it is to be understood that the second partial-cylindrical corner 224 has an arc that is the same as, or similar to, the arc A of the first partial-cylindrical corner 222.

Further, as depicted in FIG. 11, the first partial-cylindrical corner 222 includes a radius R. Moreover, the pouch cell 202 defines a corner distance D that is measured from the center C of the partial-cylindrical corner 222 to the vertex V of the corner of the pouch cell 202. In a particular aspect, the corner distance D is less than the radius R such that a gap G is formed between the inner wall of the partial-cylindrical corner 222 and the vertex V of the corner of the pouch cell 202. In a particular aspect, the gap G is equal to the radius R minus the corner distance D. Further, the gap G is greater than or equal to 0.150 R, such as greater than or equal to 0.155 R, greater than or equal to 0.160 R, greater than or equal to 0.165 R, greater than or equal to 0.170 R, and greater than or equal to 0.175 R. In another aspect, the gap G is less than or equal to 0.200 R, such as less than or equal to 0.195 R, less than or equal to 0.190 R, less than or equal to 0.185 R, or less than or equal to 0.180 R. It is to be understood that the gap G may within a range between, and including, the minimum and maximum values of G disclosed herein. Further, it is to be understood that the second partial-cylindrical corner 224 is sized and shaped in a manner similar to, or the same as, the first partial-cylindrical corner 222.

In a particular aspect, the partial-cylindrical corners 222, 224 substantially minimize, or eliminate, the stress concentration that would exist if the sidewalls 214, 214 met the rear wall 216 at sharp corners. Further, the partial-cylindrical corners 222, 224 provide substantial clearance for the corners of the pouch cell 202. Additionally, the partial-cylindrical corners 222, 224 provide protection for the corner “dog ears” of the pouch cell 202.

As shown, the rear wall 216 further includes a first mounting cylinder 226 on a first side of the central axis 134 and a second mounting cylinder 228 on a second side of the central axis 134 opposite the first mounting cylinder 226. Each mounting cylinder 226 includes a central bore that is configured to receive a screw. During assembly of the battery pack 100, the mounting cylinders 226, 228 receive screws to hold a lower plate of a printed circuit board assembly.

FIG. 10 further indicates that the battery pack 100 includes a first tongue-and-groove assembly 230 on a first side of the central axis 134 and a second tongue-and-groove assembly 232 and a second side of the central axis 134 opposite the first tongue-and-groove assembly 232. The tongue-and-groove assemblies 230, 232 are aligned along a transverse axis 234 that is perpendicular to the central axis 134. The tongue-and-groove assemblies 230, 232 are substantially identical to each other. Moreover, as indicated in FIG. 11, the first tongue-and-groove assembly 230 includes a groove 240 formed in the first sidewall 212 of the core housing 200. The groove 240 extends at least partially along the height of the first sidewall 212. As illustrated, the channel 240 is flanked by a first sidewall 242 and a second sidewall 244.

In a particular aspect, the groove 240 has a depth D measured from an outer surface 246 of the first sidewall 212 to the base of the groove 240. Also, the first sidewall 212 has a thickness T measured from the outer surface 246 of the first sidewall 212 to an inner surface 248 of the first sidewall 212. In a particular aspect, the depth D of the groove 240 is greater than or equal to 0.150 T, such as greater than or equal to 0.155 T, greater than or equal to 0.160 T, greater than or equal to 0.165 T, greater than or equal to 0.170 T, and greater than or equal to 0.175 T. In another aspect, the depth D is less than or equal to 0.200 T, such as less than or equal to 0.195 T, less than or equal to 0.190 T, less than or equal to 0.185 T, or less than or equal to 0.180 T. It is to be understood that the depth D may within a range between, and including, the minimum and maximum values of D disclosed herein.

FIG. 11 further shows that the first tongue-and-groove assembly 230 has a tongue 250 extending from an inner surface 252 of the lower battery housing portion 106. The tongue 250 extends at least partially along the height of the inner surface 252 of the lower battery housing portion 106. The tongue 250 includes a length L that is measured from the inner surface 252 of the lower battery housing portion 106 to an inner face 254 of the tongue 250. The lower battery housing portion 106 includes a wall thickness TW that is measured from an outer surface 256 of the lower battery housing portion 106 to the inner surface 252 of the lower battery housing portion 106. In particular, the length L is less than the wall thickness TW. Specifically, the length L is less than or equal to 0.95 TW, such as less than or equal to 0.90 TW, or less than or equal to 0.85 TW. Moreover, L is greater than or equal to 0.65 TW, such as greater than or equal to 0.70 TW, greater than or equal to 0.75 TW, or greater than or equal to 0.80 TW. It is to be understood that L can be within a range between, and including, any of the maximum and minimum values of L disclosed herein. It is to be further understood that the second tongue-and-groove assembly 232 is substantially an identical mirror copy of the first tongue-and-groove assembly 232 is includes the same features and dimensions as the first tongue-and-groove assembly 230.

When the core housing 200 is installed in the lower battery housing portion 106 as illustrated in FIG. 12, the tongues 250 fit into the grooves 240. Each of a plurality of screws 260 extends through a respective screw boss 262 on a printed circuit board assembly (PCBA) 264 to hold the PCBA 264 in place with respect to the lower battery housing portion 106. The tongue-and-groove assemblies 230, 232 substantially restrict relative movement between the core housing 200 and the lower battery housing portion 106. Further, the tongue-and-groove assemblies 230, 232 substantially reduce any load transmitted through the screw bosses 262. While the screws 260 directly engage the PCBA 264, the load bypasses the PCBA 264 and is transmitted to the core housing 200. A front endplate 266 is disposed within the opening 220 of the front wall 218 of the core housing 200. The front endplate 266 includes one or more components that are electrically and operably coupled to the pouch cells 202 within the core housing 200 and electrically and operably coupled to the PCBA 264.

FIGS. 9 and 12-14 show that the core housing 200 further includes a first PCBA retainer clip 270 and a second PCBA retainer clip 272 on a first side of the central axis 134. Moreover, the core housing 200 includes a third PCBA retainer clip 274 and a fourth PCBA retainer clip 276 on a second side of the central axis 134 opposite the first and second retainer clips 270, 272. As best shown in FIG. 9, each PCBA retainer clip 270, 272, 274, 276 extends in a generally upward direction from a respective sidewall 212, 214 of the core housing 200 and includes a retainer wall 278 having a distal end clip 280. The distal end clip 280 is generally triangular and increases in width from top to bottom. As such, the PCBA 264 can slide past the distal end clips 280 of PCBA retainer clips 270, 272, 274, 276 and snap into place on top of the core housing 200 as depicted in FIGS. 12-14.

FIGS. 9 and 12-14 indicate that the core housing 200 also includes a first PCBA alignment tab 290, a second PCBA alignment tab 292, and a third PCBA alignment tab 294 on a first side of the central axis 134. Further, the core housing 200 includes a fourth PCBA alignment tab 296, a fifth PCBA alignment tab 298, and sixth PCBA alignment tab 300 on a second side of the central axis 134 opposite the first, second, and third PCBA tabs 290, 292, 294. As best shown in FIG. 9, the first and fourth PCBA alignment tabs 290, 296 extend in a generally upward direction from the rear wall 216 of the core housing 200 and are coplanar with the rear wall 216. The second and third PCBA alignment tabs 292, 294 extend in a generally upward direction from the first sidewall 212 of the core housing 200 and are coplanar with the first sidewall 212. The fifth and sixth PCBA alignment tabs 298, 300 extend in a generally upward direction from the second sidewall 214 of the core housing 200 and are coplanar with the second sidewall 214. A shown, the first and fourth PCBA alignment tabs 290, 296 are perpendicular to the second, third, fifth, and sixth PCBA alignment tabs 292, 294, 298, 300. Further, the alignment tabs 290, 292, 294, 296, 298, 300 extend in the same direction as the retainer clips 270, 272, 274, 276.

FIG. 9 further shows that the core housing 200 also includes a first front endplate alignment tab 310 that extends in a forward direction from the first sidewall 212 (i.e., in a direction perpendicular to the second and third PCB alignment tabs 292, 294.) The first front endplate alignment tab 310 is coplanar with the first sidewall 212. The core housing 200 also includes an endplate clip receiving slot 314 formed in a respective sidewall 212, 214 adjacent to each front endplate alignment tab 310, 312.

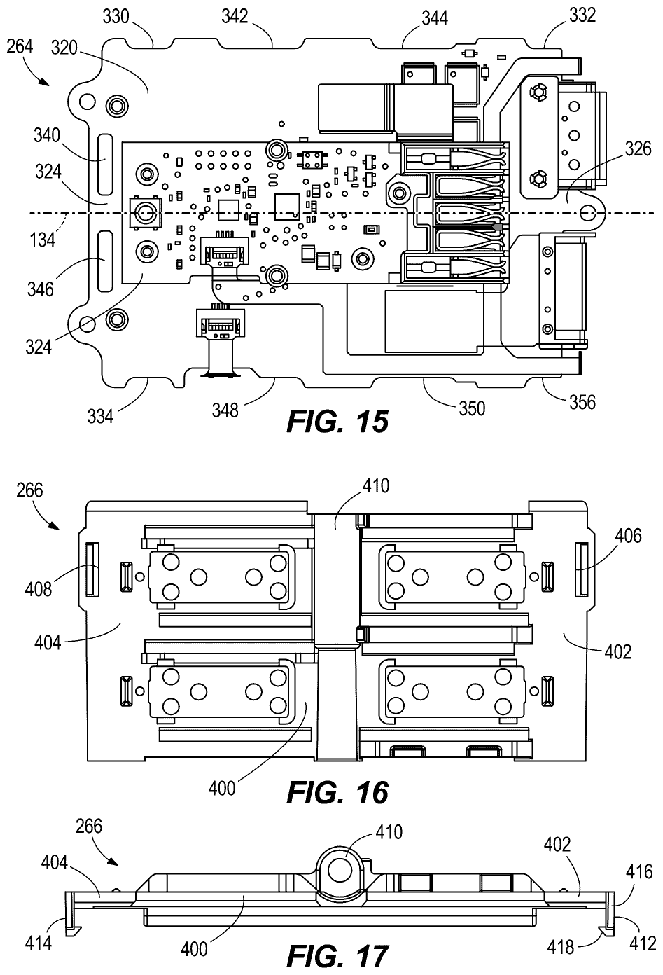

FIG. 15 illustrates the details of the PCBA 264. As shown, the PCBA 264 includes an upper board 320 and a lower board 322. The lower board 320 includes a first end 324 and a second end 326. The lower board 320 includes a first attachment slot 330 adjacent the first end 324 and a second attachment slot 332 adjacent the second end 326 formed in an edge of the PCBA 264 on a first side of the central axis 134. The lower board 320 also includes a third attachment slot 334 adjacent the first end 324 and a fourth attachment slot 336 adjacent the second end 326 formed in an edge of the PCBA 264 on a second side of the central axis 134.

FIG. 15 further shows that the lower board 320 includes a first alignment slot 340 adjacent the first end 324 on the first side of the central axis 134. The lower board 320 also includes a second alignment slot 342 and a third alignment slot 344 between the first and second attachment slots 330, 332 on the first side of the central axis 134. As shown, the lower board 320 further includes a fourth alignment slot 346 adjacent the first end 324 on the second side of the central axis 134. Moreover, the lower board 320 includes a fifth alignment slot 348 and a sixth alignment slot 350 between the third and fourth attachment slots 334, 336 on the second side of the central axis 134.

When the PCBA 264 is installed on the core housing 200, the first alignment slot 340 fits over the first PCBA alignment tab 290. The second alignment slot 342 fits around the second PCBA alignment tab 292. The third alignment slot 344 fits around the third PCBA alignment tab 294. Moreover, the fourth alignment slot 346 fits over the fourth PCBA alignment tab 296. The fifth alignment slot 348 fits around the fifth PCBA alignment tab 298. The sixth alignment slot 350 fits around the sixth PCBA alignment tab 300. The cooperation of the tabs 290, 292, 294, 296, 298, 300 and the slots 340, 342, 344, 346, 348, 350 control the placement of the PCBA 264 on the core housing 200 to assist the assembly of the battery pack 100 as the PCBA 264 is snapped onto the core housing 200, as described herein.

As the PCBA 264 is installed, under guidance of the tabs 290, 292, 294, 296, 298, 300 and the slots 340, 342, 344, 346, 348, 350, the first attachment slot 330 slides past the first PCBA retainer clip 270 and snaps in place under the distal end clip 280 thereof. The second attachment slot 332 slides past the second PCBA retainer clip 272 and snaps in place under the distal end clip 280 thereof. The third attachment slot 334 slides past the third PCBA retainer clip 274 and snaps in place under the distal end clip 280 thereof. Finally, the fourth attachment slot 336 slides past the fourth PCBA retainer clip 276 and snaps in place under the distal end clip 280 thereof. The retainer clips 270, 272, 274, 276 cooperate with and engage the attachment slots 330, 332, 334, 336 to retain the PCBA 264 on the top of the core housing 200 and can substantially withstand the forces caused by expansion of the pouch cells 202 within the core housing 200.

FIGS. 16 and 17 illustrate the details of the front endplate 266. As shown, the front endplate 266 includes a generally flat body 400 having a first end 402 and a second end 404. The front endplate 266 includes a first endplate alignment slot 406 adjacent the first end 402 and a second endplate alignment slot 408 adjacent the second end 404. The front endplate 266 also includes a third mounting cylinder 410. The third mounting cylinder 410 includes a central bore that is configured to receive a screw. During assembly of the battery pack 100, the third mounting cylinders 410 receives a screw 260 to hold the lower plate 320 of the PCBA 264 on the core housing 200.

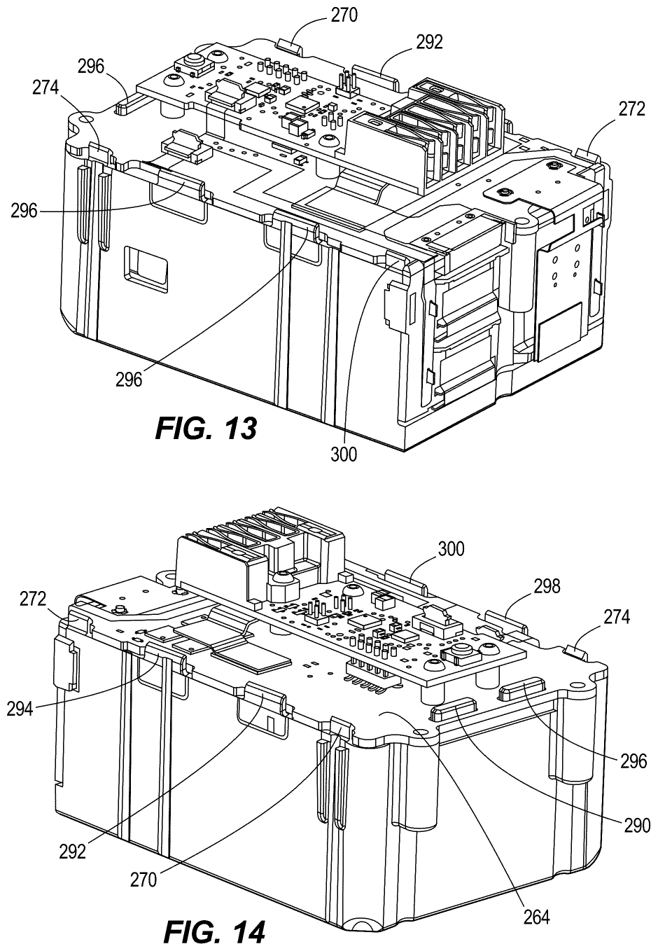

The front endplate 266 further includes a first endplate retainer clip 412 adjacent the first endplate alignment slot 406 and a second endplate retainer clip 414 adjacent the second endplate alignment slot 406. Each endplate retainer clip 412, 414 includes a retainer wall 416 and a distal end clip 418. When the front endplate 266 is installed on the core housing 200 as illustrated in FIG. 13 the first endplate alignment slot 406 first over the first front endplate alignment tab 310. The second endplate alignment slot 408 fits over the second front endplate alignment tab 312. The endplate retainer clips 412, 414 on the front endplate 266 fit into respective endplate clip receiving slots 314 on the core housing 200. The cooperation of the tabs 310, 312 and the slots 404, 406 control the placement of the front endplate 266 on the core housing 200 to assist the assembly of the battery pack 100 as the front endplate 266 is snapped onto the core housing 200, as described herein. The endplate retainer clips 412, 414 cooperate with and engage the endplate clip receiving slots 314 to retain the front endplate 266 on the front of the core housing 200 and can substantially withstand the forces caused by expansion of the pouch cells 202 within the core housing 200.

Although the disclosure has been described in detail with reference to certain preferred embodiments, variations and modifications exist within the scope and spirit of one or more independent aspects of the disclosure as described.

What is claimed is:

1. A battery pack comprising:
a battery housing;
a core housing disposed within the battery housing; and
at least one pouch cell disposed within the core housing, the pouch cells including at least one corner,
wherein the core housing includes
a baseplate;
at least one sidewall extending from the baseplate; and
a rear wall extending from the baseplate to the sidewall,
wherein the rear wall meets the sidewall at a partial-cylindrical corner and wherein the partial-cylindrical corner provides clearance for the corner of the pouch cell.

2. The battery pack of claim 1, wherein each of the partial-cylindrical corner defines an arc A, that is greater than or equal to one-hundred twenty degrees (120°).

3. The battery pack of claim 2, wherein the arc A is less than or equal to two-hundred degrees (200°).

4. The battery pack of claim 1, wherein the partial-cylindrical corner includes a radius R and a center C, wherein the pouch cell defines a corner distance D measured from the center C to a vertex V of the corner of the pouch cell, and wherein the corner distance D is less than the radius R such that a gap G is formed between an inner wall of the partial-cylindrical corner and the vertex V of the corner of the pouch cell.

5. The battery pack of claim 4, wherein the gap G is greater than or equal to 0.150 R.

6. The battery pack of claim 5, wherein the gap G is less than or equal to 0.200 R.

7. A battery pack comprising:
a battery housing having an upper battery housing portion and a lower battery housing portion;
a core housing disposed within the battery housing;
at least one pouch cell disposed within the core housing; and
at least one tongue-and-groove assembly that includes a tongue extending from an inner surface of the lower battery housing portion and a groove extending into an outer surface of the core housing, wherein the tongue of the lower battery housing portion fits into the groove on the core housing.

8. The battery pack of claim 7, wherein the tongue-and-groove assembly restricts relative movement between the core housing and the lower battery housing portion.

9. The battery pack of claim 8, wherein the tongue-and-groove assembly reduces a load transmitted through one or more screw bosses on a printed circuit board assembly disposed on the core housing.

10. A battery pack comprising:
a battery housing having an upper battery housing portion and a lower battery housing portion;
a core housing disposed within the battery housing, the core housing include at least one printed circuit board assembly (PCBA) alignment tab extending therefrom;
at least one pouch cell disposed within the core housing; and
at least one PCBA disposed on the core housing, wherein the PCBA includes at least one alignment slot that fits around the PCBA alignment tab on the core housing.

11. The battery pack of claim 10, wherein the core housing further comprises a PCBA retainer clip extending from the core housing in the same direction as the PCBA alignment tab.

12. The battery pack of claim 11, wherein the PCBA includes at least one attachment slot formed in an edge of the PCBA wherein the PCBA retainer clip engages the attachment slot to maintain the PCBA on the core housing.

13. The battery pack of claim 10, wherein the core housing includes at least one front endplate alignment tab that extends in a direction perpendicular to the PCBA alignment tab.

14. The battery pack of claim 13, further comprising an endplate disposed on an end of the core housing, wherein the endplate includes an endplate alignment slot that fits over the endplate alignment tab.

15. The battery pack of claim 13, wherein the core housing further includes an endplate clip receiving slot adjacent the endplate alignment tab.

16. The battery pack of claim 15, wherein the endplate further comprises an endplate retainer clip adjacent the endplate alignment slot and the endplate retainer clip fits into the endplate clip receiving slot on the core housing.
